(19) United States
(12) Patent Application Publication
(10) Pub. No.: US 2018/0160255 A1
(43) Pub. Date: Jun. 7, 2018

(54) NFC TAG-BASED WEB SERVICE SYSTEM AND METHOD USING ANTI-SIMULATION FUNCTION

(71) Applicant: Youngsuck PARK, Phohang-si (KR)

(72) Inventor: Youngsuck PARK, Phohang-si (KR)

(21) Appl. No.: 15/365,968

(22) Filed: Dec. 1, 2016

(51) Int. Cl. H04W 4/00; H04L 29/08

(52) U.S. Cl. CPC H04W 4/008; H04L 67/02

(57) ABSTRACT

An NFC tag-based Web service method based on an anti-simulation function includes a first operation of transmitting a response including URL information to the NFC reader when the NFC tag recognizes tagging of the NFC reader, and a second operation of receiving the URL information, by the Web server, the URL information from the mobile Internet device, and transmitting Web page information corresponding to the URL information to the mobile Internet device, wherein the URL information provided by the NFC tag to the NFC reader is varied URL information including a key changed and generated whenever tagging occurs, and the key is changed and generated according to a generation algorithm shared with the Web server.

### BACKGROUND OF THE INVENTION

### 1. Field of the Invention

The present disclosure relates to an NFC tag-based Web service system and method capable of preventing simulation of an authorized NFC tag.

### 2. Description of Related Art

A method for providing a Web service using an NFC tag storing a uniform resource locator (URL) is known. When a smartphone having an NFC reader function is tagged to an NFC tag storing a URL, the smartphone reads the URL to drive a Web browser, and the Web browser is automatically connected to a Website of the corresponding URL to receive a desired service.

In an automatic access environment of a Web service using a URL, generally, a Web browser is generally a standard application basically provided in smartphones, and the like, and a standard communication protocol such as HTTP is used in a communication procedure with respect to a server, and thus, a user may immediately use them without having to install a separate dedicated application.

For issuance of a waiting number, an order in a restaurant, accumulation of points, inventory management, patrol history management, maintenance history management, vehicle maintenance management, fire extinguish equipment inspection, and the like, enhanced convenience may be provided on the basis of a URL-stored NFC tag, a server, and the like.

URL information stored in an NFC tag, however, may be easily read and duplicated using a smartphone, or the like, and it is also easy to create a duplicated NFC tag. Thus, a user, who has not actually arrived at a place where an authorized NFC tag is installed, may simulate as if he or she has already arrived at the corresponding place to access a Web service by using the duplicated NFC tag or, more easily, by manually inputting a URL in a Web browser of a smartphone, or the like.

For example, a malicious user may make a false order outside a restaurant or a user who has not arrived at the spot may issue a waiting number in advance.

Since a service may be accessed through duplication of URL information or reproduction of an NFC tag even outside an original installation spot, the original purposes of a location-based service may not be attained and a security problem may arise.

In order to solve the security problem, some techniques may be considered. For example, a random number generating device such as an OTP device may be installed in an NFC tag and generated random numbers may be transferred to a server to authenticate the NFC tag.

Patent document 1 discloses a technique in which a card including an OTP module and an NFC module transfers an OTP through short-range communication with a terminal device such as a smartphone, and thus, a system for processing a requested service after authenticating an NFC tag using this technique may be configured.

However, in Patent document 1, in order to process an authentication procedure on an NFC tag, a process should be performed according to a dedicated communication procedure previously defined between the NFC tag and the terminal device, and thus, a dedicated application (or shortly “App”) which is to be executed is required to be installed in advance.

Installation of the dedicated application causes user inconvenience of a smartphone user and is, in particular, inconvenient in an application field in which issuance of a waiting number or an order in a restaurant is used one time, degrading a usage rate of users.

A Web service scheme using an URL-stored NFC tag and a standard application has many advantages in various applications fields, and thus, a technique capable of securing security, without trading off this environment, is required. That is, a technique of preventing simulation of an NFC tag storing a URL, while using a Web browser and a Web service scheme, is required.

Technical tasks to achieve in the present invention are not limited to the above-mentioned technical tasks. Other technical tasks which are not mentioned may be clearly understandable for those who skilled in the art of the present invention from the following description.

### RELATED ART DOCUMENT

### Patent Document

(Patent Document 1) Korean Patent Registration No. 1321174 (Registration date: Oct. 16, 2013)

### SUMMARY OF THE INVENTION

Therefore, an aspect of the present disclosure is to provide an NFC tag-based Web service method capable of preventing simulation of an NFC tag storing a URL.

Another aspect of the present disclosure is to provide an NFC tag-based Web service system capable of preventing simulation of an NFC tag storing a URL.

Technical tasks obtainable from the present invention are non-limited by the above-mentioned technical task. And, other unmentioned technical tasks can be clearly understood from the following description by those having ordinary skill in the technical field to which the present invention pertains.

In an aspect, an NFC tag-based Web service method based on an anti-simulation function, providing a Web service on the basis of an NFC tag using an NFC tag, a mobile Internet device including an NFC reader, and a Web server providing a Web service to the mobile Internet device, may include: a first operation of transmitting a response including URL information to the NFC reader when the NFC tag recognizes tagging of the NFC reader; and a second operation of receiving the URL information, by the Web server, the URL information from the mobile Internet device, and transmitting Web page information corresponding to the URL information to the mobile Internet device, wherein the URL information provided by the NFC tag to the NFC reader is varied URL information including a key changed and generated whenever tagging occurs, and the key is changed and generated according to a generation algorithm shared with the Web server.

The key may be a counter value increased or decreased cooperatively according to tagging or a calculation value using at least the counter value as an input.

The key may be a one-time password (OTP) value or a calculation value using at least the OTP value as an input.

The first operation may include: (1-1)th operation of generating the key after receiving a request from the NFC reader; and (1-2)th operation of generating the varied URL information by inserting the key generated in (1-1)th operation into fixed URL information stored as a fixed value in the NFC tag or replacing a portion of the fixed URL information with the key generated in the (1-1)th operation.

The second operation may include: (2-1)th operation of extracting a key from the varied URL information, after receiving the varied URL information from the mobile Internet device; (2-2)th operation of verifying validity of the extracted key according to the shared generation algorithm; and (2-3)th operation of approving provision of a Web service to the mobile Internet device when the extracted key is a normal key according to the validity verification result.

The method may further include: (2-4)th operation of not approving provision of a Web service to the mobile Internet device, when the extracted key is an abnormal key according to the validity verification result.

The key may be included in a parameter area of a URL.

The key may be included in a directory or a file name of a URL.

In another aspect, an NFC tag-based Web service system having an anti-simulation function, including an NFC tag providing URL information to an NFC reader installed in a mobile Internet device when the NFC reader tags and a Web server receiving the URL information from the mobile Internet device and providing a Web service to the mobile Internet device, wherein the URL information provided by the NFC tag to the NFC reader is varied URL information changed and generated whenever tagging occurs, and the key is changed and generated according to a generation algorithm shared with the Web server.

The NFC tag may include: a first key generator generating a counter value increased or decreased cooperatively according to the tagging, a calculation value using at least the counter value as an input, a one-time password (OTP) value interworking with time at the time of the tagging, or a calculation value using at least the OTP value as an input, as the key; and a modifier generating the varied URL information by inserting a key generated by the first key generator into fixed URL information stored as a fixed value in the NFC tag or replacing a portion of the fixed URL information with the generated key.

The Web server may include: a second key generator generating a key by itself according to the shared generation algorithm; an inspector verifying validity of a key included in the varied URL information received from the mobile Internet device, in cooperation with the second key generator; and a WAS providing a Web service to the mobile Internet device when the key included in the varied URL information is a normal key according to the validity verification result.

The key may be included in a parameter area of a URL.

The key may be included in a directory or a file name of a URL.

According to the present disclosure, the use of simulation of an NFC tag, while using the Web browser basically provided in a smartphone, or the like, and the standard Web service scheme such as the HTTP protocol, is prevented.

Also, according to the present disclosure, since URL information provided by the NFC tag is provided such that the URL information is verified, a hazard due to duplication of the NFC tag is prevented and security may be increased.

In addition, according to the present disclosure, for the purpose of issuance of a waiting number, an order in a restaurant, accumulation of points, inventory management, patrol history management, maintenance history management, vehicle maintenance management, fire extinguish equipment inspection, and the like, enhanced convenience may be provided on the basis of a URL-stored NFC tag, a Web server, and the like, while a problem that a user, who has not arrived at a place where an NFC tag is installed, accesses a corresponding service only by a duplicated URL to simulate as if he or she is present on the spot may be prevented. Thus, since enhanced security, while supporting user convenience of the URL access scheme, is provided, the need to install a dedicated application may be eliminated in various fields requiring security.

### BRIEF DESCRIPTION OF DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram illustrating a configuration of a near-field communication (NFC) tag-based Web service system according to an embodiment of the present disclosure.

FIG. 2 is a flow chart illustrating an NFC tag-based Web service method based on an anti-simulation function according to an embodiment of the present disclosure.

FIG. 3 is a table illustrating fixed URL information and varied URL information when one-time password (OTP) values of FIG. 3A or counter values of FIG. 3B are used as keys and the keys are included in a parameter area according to an embodiment of the present disclosure.

FIG. 4 is a table illustrating fixed URL information and varied URL information when OTP values of FIG. 4A or counter values of FIG. 4B are used as keys and the keys are included in a directory of a URL according to an embodiment of the present disclosure.

### DETAILED DESCRIPTION OF THE INVENTION

Hereinafter, exemplary embodiments will be described in detail with reference to the accompanying tables and drawings such that they can be easily practiced by those skilled in the art to which the present invention pertains. As those skilled in the art would realize, the described embodiments may be modified in various different ways, all without departing from the spirit or scope of the present invention. In the accompanying drawings, a portion irrelevant to description of the present invention will be omitted for clarity, and like reference numerals refer to like elements throughout.

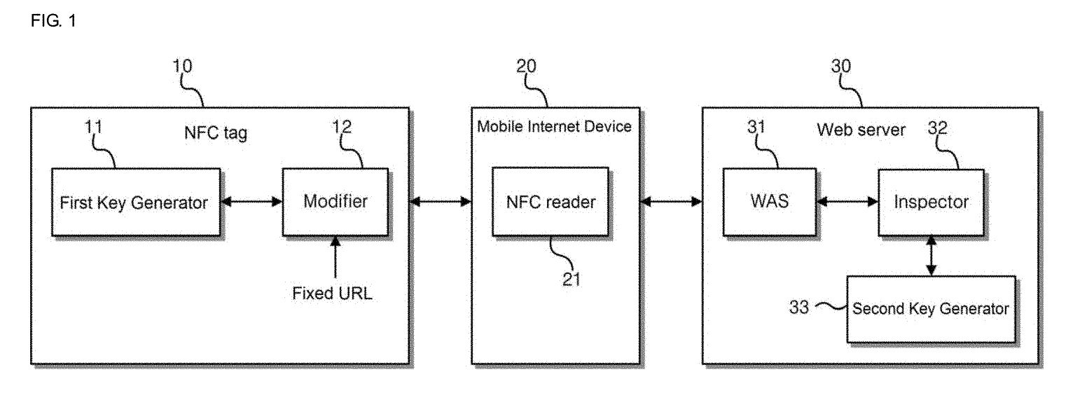

FIG. 1 is a block diagram illustrating a configuration of an NFC tag-based Web service system according to an embodiment of the present disclosure.

A near-field communication (NFC) tag-based Web service system according to an embodiment of the present disclosure includes a mobile Internet device 20 including an NFC reader 21, an NFC tag 10 providing URL information to the NFC reader 21 when the NFC reader 21 is tagged, and a Web server 30 receiving URL information from the mobile Internet device 20 and providing a Web service to the mobile Internet device 20.

The mobile Internet device 20 is a portable terminal such as a smartphone, a tablet PC, a personal digital assistant (PDA), and the like, including at least an Internet communication function and a Web browser as software. The mobile Internet device 20 may have the NFC reader 21 internally or externally. The mobile Internet device 20 may be particularly configured to implement the present disclosure or a dedicated application may not need to be installed.

The NFC tag 10 refers to a general “NFC tag” independently present, without being connected to an external power source.

The NFC tag 10, storing fixed URL information, as a fixed value, may include a first key generator 11 and a modifier 12. The fixed URL information may be stored in a non-volatile memory area.

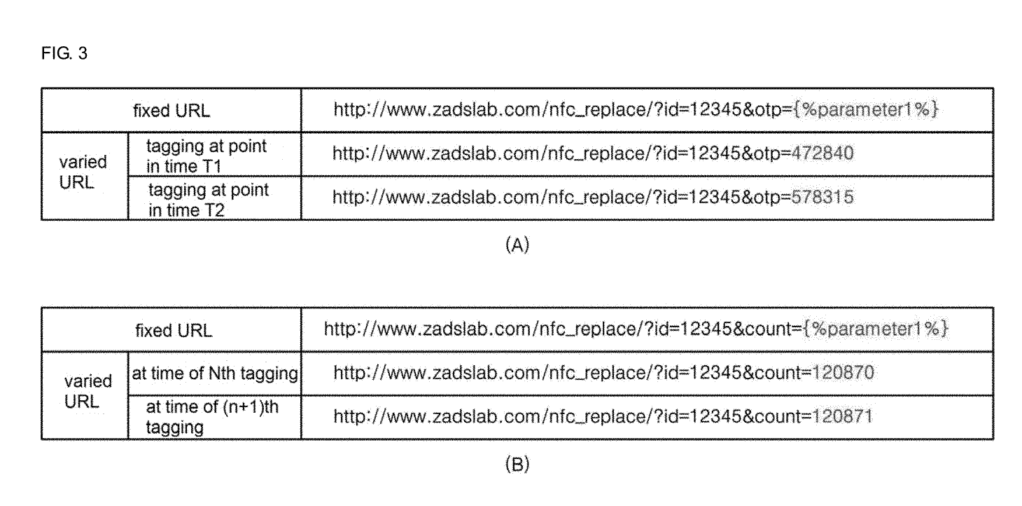

For example, the fixed URL information may be “http://www.zadslab.com/nfc_replace/?id=12345&otp={% parameter1%}” or “http://www.zadslab.com/nfc_replace/?id=12345&count={% parameter1%}” as illustrated in FIG. 3.

The fixed URL information includes a protocol, a domain name, a directory, a file name, a parameter area, and the like, in conformity with a standard URL configuration rule, and the parameter area may include identifiers (IDs) for identifying an NFC tag, a menu, a Web service, a tag attachment position, a tag attachment target, and the like, and a token area displaying an area to be replaced with a “key” when a varied URL is generated afterwards.

Also, as described hereinafter, in the fixed URL information, the token area may be omitted and a “key” may be inserted according to a predefine scheme to thereby generate varied URL information.

The first key generator 11 generates a counter value increased or decreased cooperatively according to tagging of the NFC reader 21, a calculation value using at least the counter value as an input, a one-time password (OTP) value interworking with a time at the time of tagging, or a calculation value using the OTP value as an input, as a “key”.

The first key generator 11 may include a counter or an OTP device or may be a counter or an OTP implemented by software using a general processor, hardware of an NFC chip, and the like.

The counter value may be used by the modifier 12 as is, or the counter value and a stored code value may be XORed or the counter value may be encrypted according to a simple encryption algorithm to output a calculation value using the counter value as an input, so as to be used by the modifier 12. Also, regarding the OTP value, a calculation value may be generated on the basis of the OTP value as an input, so as to be used by the modifier 12.

Also, calculation may be performed by the modifier 12. In order to generate the OTP value, the NFC tag 10 may additionally have a battery and a clock therein.

The modifier 12 generates varied URL information by inserting a key generated by the first key generator 11 into the fixed URL information stored as a fixed value in the NFC tag 10 or replacing a portion of the fixed URL information with the generated key.

URL information provided by the NFC tag 10 to the NFC reader 21 is varied URL information including a key changed and generated whenever tagging occurs, and the key is changed and generated according to a generation algorithm shared with the Web server 30.

An algorithm based on which the first key generator 11 generates “key” is shared with the Web server 30, and thus, the Web server 30 may verify validity of the generated key.

The modifier 12 may include the generated key in the parameter area of the URL or in the directory or the file name of the URL.

As illustrated in FIGS. 3A and 3B, the modifier 12 may replace {% parameter1%} of the parameter area with “472840” as an OTP value, or “120870” as a counter value, for example, to generate varied URL information.

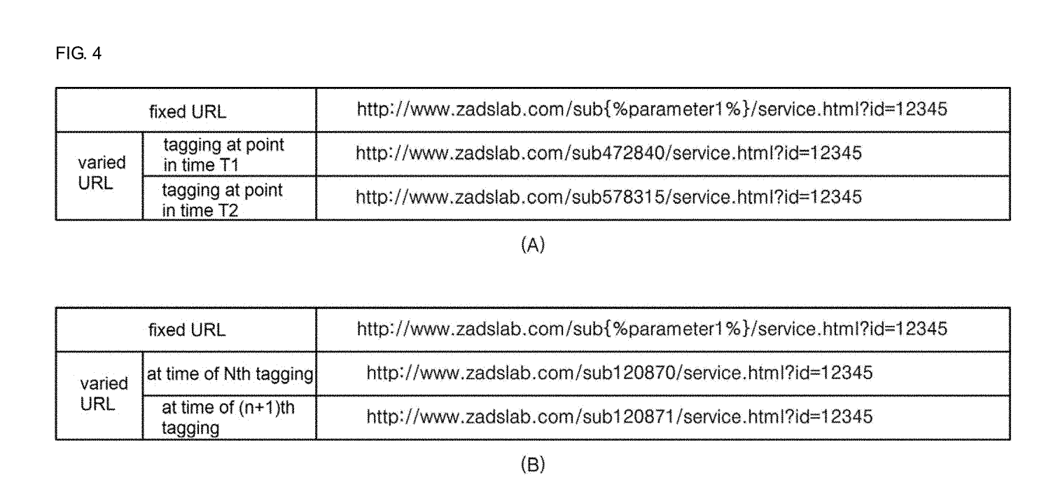

Alternatively, as illustrated in FIGS. 4A and 4B, the modifier 12 may replace {% parameter1%} of the directory (or the file name (not shown), etc.) of the fixed URL with “472840” as an OTP value or with “120870” as a counter value, for example, to generate varied URL information.

Inclusion of the key in the directory or the file name of the varied URL information may have an effect of making it difficult for a third party to recognize a usage purpose.

Also, since the key is changed and generated, the key has a value continuously changed according to the number of taggings and a tagging point of time. The varied URL information generated by the modifier 12 is transmitted to the mobile Internet device 20, as a response.

The Web server 30 includes a second key generator 33 generating a key according to a shared generation algorithm, an inspector 32 verifying validity of a key included in varied URL information transmitted from the mobile Internet device 20, in cooperation with the second key generator 33, and a WAS 31 providing a Web service to the mobile Internet device 20 when the key is a normal key according to a result of verification of validity thereof and rejecting provision of a Web service when the key is an abnormal key according to the result of verification of validity thereof. The second key generator 33, the inspector 32, and the WAS 31 may be functional software blocks.

The second key generator 33, which corresponds to the first key generator 11 of the NFC tag 10, generates a key by itself using the generation algorithm shared with the NFC tag 10, and generates an increased or decreased counter value, a calculation value using at least the counter value as an input, an OTP value interworking with time, or a calculation value using the OTP value as an input, as a “key”. To this end, the second key generator 33 may receive and use identifiers (IDs) for identifying an NFC tag, a menu, a Web service, a tag attachment position, a tag attachment target, and the like, included in the received varied URL information, and store a final counter value determined to be normal in a previous validity verification process. The second key generator 33 may store a previous counter value of each of the identifiers (IDs), store a serial number of an OTP of each of the identifiers (IDs) and access an internal OTP server or a remote OTP server, or store an OTP generation algorithm or a parameter of the generation algorithm according to each of the identifiers (IDs).

The inspector 32 verifies validity of the key included in the varied URL information received from the mobile Internet device 20 in cooperation with the second key generator 33. Here, the inspector 32 transfers the received identifier (ID) and the key to the second key generator 33, receive a key generated by the second key 33 by itself, and compare the received key and the key generated by the second key generator 33, to thereby verify validity of the key, and provide the verification result to the WAS 31.

In the process of verifying the key, when the received counter value and the generated counter value are identical within a predetermined range in consideration of a situation in which the Web server 30 fails to effectively receive varied URL information due to a communication error, or the like, after tagging on the NFC tag, the inspector 32 may determine the key is normal. Similarly, an OTP value generated by itself in consideration of a clock error, transmission delay, and the like, between the NFC tag 10 and the Web server 30, may be compared with an OTP value of a time zone obtained by adding a predetermined range to a point in time at which the OTP value is generated.

The WAS 31 receives a request for a Web service from a Web browser of the mobile Internet device 20 according to a protocol such as an HTTP, or the like, and receives varied URL information at the time. Here, for example, the varied URL information may be transmitted according to a GET scheme of the HTTP.

Also, the WAS 31 may transfer the received varied URL information or identifier (ID) and the key to the inspector 32, request verification of validity of the key, while transferring the varied URL information or the identifier (ID) and the key to the inspector 32, and receive a validity verification result in response to the request. When the key is a normal key according to the validity verification result, the WAS 31 provides a Web service to the mobile Internet device 20, and when the key is an abnormal key according to the validity verification result, the WAS 31 rejects provision of the Web service. Here, when the key is a normal key, the WAS 31 may provide a service page to execute a Web service, and when the key is an abnormal key, the WAS 31 may provide an error page and perform exception handling.

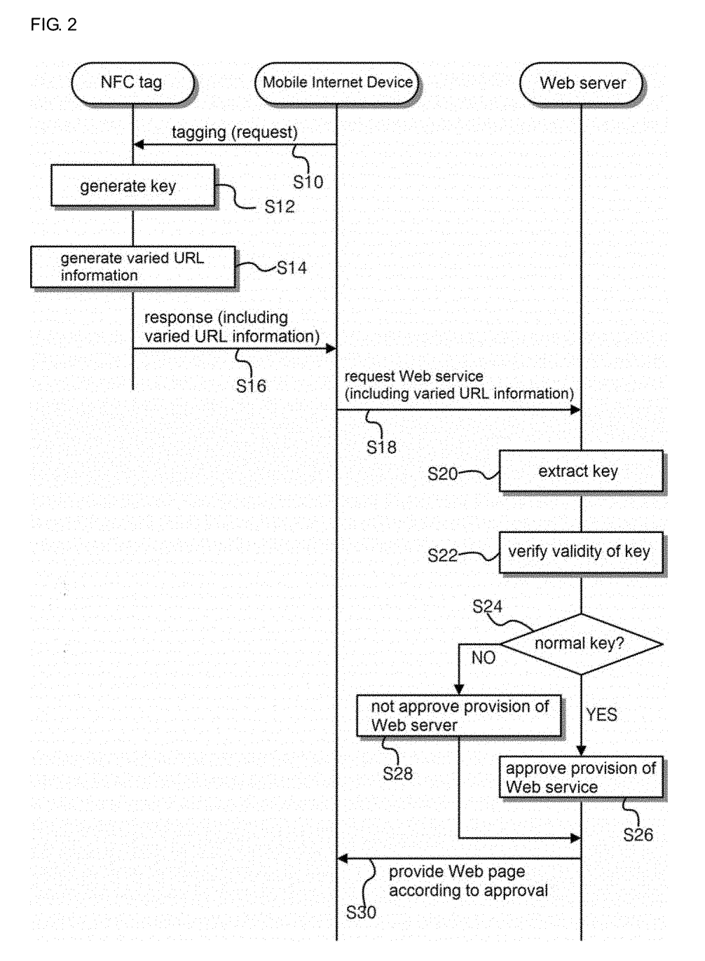

FIG. 2 is a flow chart illustrating an NFC tag-based Web service method using an anti-simulation function according to an embodiment of the present disclosure.

The flow chart of FIG. 2 is merely illustrative and the scope of the present disclosure should not be construed to be limited thereto, and for matters not mentioned in FIG. 2 and related descriptions thereof, descriptions regarding the NFC tag-based Web service system may be considered.

An NFC tag-based Web service method according to an embodiment of the present disclosure is performed using the NFC tag 10, the mobile Internet device 20 including the NFC reader 21, and the Web server 30 providing a Web service to the mobile Internet device 20.

First, as the NFC reader 21 installed in the mobile Internet device 20 tags (S10), the mobile Internet device 20 may request transmission of URL information from the NFC tag 10, and here, if the NFC tag 10 does not have an internal battery, the NFC tag 10 may receive required power in a form of wireless radio waves.

When the NFC tag 10 recognizes tagging (request) from the mobile Internet device 20, the NFC tag 10 generates a key according to a shared generation algorithm (S12) and generates varied URL information by inserting the generated key into fixed URL information stored as a fixed value in the NFC tag 10 or replacing a portion of the fixed URL information with the generated key (S14). Also, the NFC tag 10 transmits a response including the varied URL information to the NFC reader 21 of the mobile Internet device 20 using a known backscattering method, or the like (S16).

Here, the URL information provided by the NFC tag 10 to the NFC reader 21 is varied URL information including a key changed and generated whenever tagging occurs, and the key is generated upon being changed according to the generation algorithm shared with the Web server 30. The key is included in the parameter area of the URL or in the directory or file name of the URL.

Also, the key may be a counter value increased or decreased cooperatively according to tagging or a calculation value using at least the counter value as an input, or may be an OTP value or a calculation value using at least the OTP value as an input.

The mobile Internet device 20 drives a Web browser and transmits the received varied URL information to request a Web service from the corresponding Web server 30 using the varied URL information (S18).

The Web server 30 receives the varied URL information from the mobile Internet device 20 and transmits Web page information corresponding to the varied URL information to the mobile Internet device 20. Details thereof will be described hereinafter.

After receiving the varied URL information from the mobile Internet device 20, the Web server 30 extracts a key from the varied URL information (S20) and verifies validity of the extracted key according to the shared generation algorithm (S22). A specific method thereof is the same as that described above.

When the key is a normal key according to the validity verification result, the Web server 30 approves provision of the Web service to the mobile Internet device 20 (S26), and when the key is an abnormal key, the Web server 30 does not approve provision of the Web service to the mobile Internet device 20 (S28).

The Web server 30 provides the corresponding Web page according to the approval (S30). When the key is a normal key, the Web server 30 provides the requested Web service to the mobile Internet device 20. Here, the Web server 30 provides corresponding service pages by stages, starting from a first service page, to execute the Web service. When the key is an abnormal key, the Web server 30 rejects provision of the web service. That is, the Web server 30 provides an error page and performs exception handling.

As described above, according to the present disclosure, the use of simulation of an NFC tag, while using the Web browser basically provided in a smartphone, or the like, and the standard Web service scheme such as the HTTP protocol, is prevented.

Also, according to the present disclosure, since URL information provided by the NFC tag is provided such that the URL information is verified, a hazard due to duplication of the NFC tag is prevented and security may be increased.

In addition, according to the present disclosure, for the purpose of issuance of a waiting number, an order in a restaurant, accumulation of points, inventory management, patrol history management, maintenance history management, vehicle maintenance management, fire extinguish equipment inspection, and the like, enhanced convenience may be provided on the basis of a URL-stored NFC tag, a Web server, and the like, while a problem that a user, who has not arrived at a place where an NFC tag is installed, accesses a corresponding service only by a duplicated URL to simulate as if he or she is present on the spot may be prevented. Thus, since enhanced security, while supporting user convenience of the URL access scheme, is provided, the need to install a dedicated application may be eliminated in various fields requiring security.

Although the present invention has been shown and described with respect to specific exemplary embodiments, it will be obvious to those skilled in the art that the present invention may be variously modified and altered without departing from the spirit and scope of the present invention as defined by the following claims.

What is claimed is:

1. An NFC tag-based Web service method based on an anti-simulation function, providing a Web service on the basis of an NFC tag using an NFC tag, a mobile Internet device including an NFC reader, and a Web server providing a Web service to the mobile Internet device, the method comprising:
a first operation of transmitting a response including URL information to the NFC reader when the NFC tag recognizes tagging of the NFC reader; and
a second operation of receiving the URL information, by the Web server, the URL information from the mobile Internet device, and transmitting Web page information corresponding to the URL information to the mobile Internet device,
wherein the URL information provided by the NFC tag to the NFC reader is varied URL information including a key changed and generated whenever tagging occurs, and the key is changed and generated according to a generation algorithm shared with the Web server.

2. The NFC tag-based Web service method of claim 1, wherein
the key is a counter value increased or decreased cooperatively according to tagging or a calculation value using at least the counter value as an input.

3. The NFC tag-based Web service method of claim 1, wherein
the key is an OTP value or a calculation value using at least the OTP value as an input.

4. The NFC tag-based Web service method of claim 1, wherein
the first operation comprises:
(1-1)th operation of generating the key after receiving a request from the NFC reader; and
(1-2)th operation of generating the varied URL information by inserting the key generated in (1-1)th operation into fixed URL information stored as a fixed value in the NFC tag or replacing a portion of the fixed URL information with the key generated in the (1-1)th operation.

5. The NFC tag-based Web service method of claim 1, wherein
the second operation comprises:
(2-1)th operation of extracting a key from the varied URL information, after receiving the varied URL information from the mobile Internet device;
(2-2)th operation of verifying validity of the extracted key according to the shared generation algorithm; and
(2-3)th operation of approving provision of a Web service to the mobile Internet device when the extracted key is a normal key according to the validity verification result.

6. The NFC tag-based Web service method of claim 5, further comprising:
(2-4)th operation of not approving provision of a Web service to the mobile Internet device, when the extracted key is an abnormal key according to the validity verification result.

7. An NFC tag-based Web service system having an anti-simulation function, comprising:
an NFC tag providing URL information to an NFC reader installed in a mobile Internet device when the NFC reader tags; and
a Web server receiving the URL information from the mobile Internet device and providing a Web service to the mobile Internet device,
wherein the URL information provided by the NFC tag to the NFC reader is varied URL information changed and generated whenever tagging occurs, and the key is changed and generated according to a generation algorithm shared with the Web server.

8. The NFC tag-based Web service system of claim 7, wherein
the NFC tag comprises:
a first key generator generating a counter value increased or decreased cooperatively according to the tagging, a calculation value using at least the counter value as an input, an OTP value interworking with time at the time of the tagging, or a calculation value using at least the OTP value as an input, as the key; and
a modifier generating the varied URL information by inserting a key generated by the first key generator into fixed URL information stored as a fixed value in the NFC tag or replacing a portion of the fixed URL information with the generated key.

9. The NFC tag-based Web service system of claim 7, wherein
the Web server comprises:
a second key generator generating a key by itself according to the shared generation algorithm;
an inspector verifying validity of a key included in the varied URL information received from the mobile Internet device, in cooperation with the second key generator; and
a WAS providing a Web service to the mobile Internet device when the key included in the varied URL information is a normal key according to the validity verification result.

10. The NFC tag-based Web service system of claim 1, wherein
the key is included in a parameter area of a URL.

11. The NFC tag-based Web service system of claim 1, wherein
the key is included in a directory or a file name of a URL.

12. The NFC tag-based Web service system of claim 7, wherein
the key is included in a parameter area of a URL.
